(19) United States
(12) Patent Application Publication
(10) Pub. No.: US 2008/0276427 A1
(43) Pub. Date: Nov. 13, 2008

(54) Rotating caster used in children's furniture

(75) Inventor: Roberto Nicola Schioppa, San Paulo (BR)

Correspondence Address: COLLARD & ROE, P.C., 1077 NORTHERN BOULEVARD, ROSLYN, NY, 11576, US

(73) Assignee: METALURGICA SCHIOPPA LTDA.

(21) Appl. No.: 11/977,121

(22) Filed: Oct. 23, 2007

(30) Foreign Application Priority Data
May 8, 2007 (BR) PI 0701644-1

(51) Int. Cl. B60B 33/00

(52) U.S. Cl. 16/35 R

(57) ABSTRACT

A rotating caster used in children's furniture represented by a solution allowing the utilization of a rotating caster very different from those frequently used in the state of the technique, and such differentiation may be translated by the fact that this device presents an organic shaped main body containing no bumps, especially those punctiform shaped, assuring the children's integrity in case of parts of their bodies colliding with the exposed faces of this type of device; also, this condition further collaborates by assuring a higher concentration power of the child towards the furniture. Furthermore, in order to assure a longer interaction of the child with the caster, the latter presents in its front part the installation of interchangeable elements, which may present all sorts of organic shapes, as long as they do not contain shoulders. This rotating caster also brings within an unheard of pulleys locking system formed by a pedal formed by a lever the intermediate part of which presents gear segments positioned beside the intermediate housing ends and which interact with the teeth of the locking ring set in the internal pulleys part.

### BACKGROUND

This application deals with an inventive nature solution on a device to facilitate the furniture movement and miscellaneous products, especially for furniture intended for the infant public, which it is distinguished of all kinds of casters solutions known in technical state because it adds values of safety, assemblage, functionality and visual presentation versatility that collaborate for a differentiated and inedited reliability condition set forth in products whose target public is the infant one.

For such predicates may be feasible, the applicant idealized a caster component whose constructiveness presents an inedited wheel movement locking system, which incorporates a differential under the products functional optics like this.

From the safety point of view, the caster is highlighted for its constructiveness to privilege organic shapes in the impact areas (components with a children's body parts), which means, without edges, corners, nebs or any kind of formation which may cause injuries in children who deal with the furniture and or with a toy.

From the commercial point of view, the abovementioned rotating caster is distinguished for presenting, in the presentation flexibility characteristic, a competitiveness differential of this device manufacturer type, where the flexibility is translated by such a constructiveness that allows the replacement of external finishing parts (body), which provides a final visual identity to the product, and therefore, the constantly necessity of change the existing visual information demanded by the infant target public.

The applicant also points out that from the functionality point of view, safety and versatility are reached without the easy assemblage characteristic be jeopardized during its manufacturing procedure.

### SUMMARY OF THE INVENTION

Aiming solely and exclusively to propitiate truth to the introductory scene context, the applicant starts to give a brief but consistent explanation about the technical state of rotating caster type devices, where an expert technician in application may recognize its deficient aspects, so that at a subsequent moment he may clearly identify, in the invent complained herein, the mandatory novelty.

The infant public, notedly formed by children, it is known that those are characterized by not presenting limits upon movements and concentration, such as;

1—) Motor coordination limits: children at that age have not yet presented their bodies movements full control, especially their members, and such occasion propitiates the occurrence of several incidents or even accidents, which in more severe cases leave the head (still fragile and under cranial consolidation stage) exposed to impacts with all sorts of objects that are in the child's action line.

2—) Concentration limits: children are notable for presenting a large mental dispersion, which means that they cannot retain attention for a long time in the same object, making their interest and perception of it to be diluted in a short period of time.

The products for infant use, in view of the motor and concentration order limitation, the products intended to the infant public shall present a constructiveness that ensure the protection requirements, and which can be translated by the absence of silhouette with punctiform shapes, or large corners, aiming to minimize the occurrence of injuries upon their impact with sensitive parts of a child's body.

The rotating casters components: Indeed, their utilization is very meaningful; they are for general and is possible to mention that their application in residential, office or still in industrial furniture is always possible;

In general the rotating caster component is represented by a simple constructive concept, translated in the formation of an assembled set of components such as rack, track and pulley with roller bearings, among others, and some even present a locking system to prevent the furniture from moving freely.

Critical analysis of the rotating casters used in children's furniture: however the component rotating caster complies with the basic function for which it was created, which means: “to provide displacement movement of products or furniture”, the same is deficient when applied in furniture and products where a child shall interact; among many deficient construction aspects one might mention:

The different types of rotating casters are not designed aiming to protect the child in case of the body's parts impact on the component parts of the device, which present corners, and also sharp-edged parts;

The rotating caster's roller locking system, in spite of being efficient may be easily disassembled by the child's action, making the furniture free to move leading to incidents or accidents;

The rotating casters do not present a possibility of visual change, which means that they do not present possibility of the distinguished finishing parts interchange;

As a result of the limitation above, the rotating caster goes unnoticed for a child, and therefore, it is not a part that motivates interaction of the child with the furniture (or another product provided with a caster); and

Whereas that most of the child time is spent close to the floor, crawling more than walking, the lowest furniture sections are nearer the child's visual field, and therefore, this furniture section should have more visual attractions.

From what has been exposed in the technical fundaments, the applicant idealized a rotating caster type device applied to a furniture (or any product) for the infant public, which brings a series of advantages when compared to the rotating casters whose construction and characteristics were revealed in the topic of the technical fundaments; but in general, it might be said that:
The rotating caster used in furniture (or any other product) for children's use presents a construction characterized by its easy assembly during the manufacturing process;
The rotating caster used in furniture (or any other product) for children's use presents a design that makes use of components made of quality material;
All components of the complained rotating caster's external part are manufactured with non-toxic raw material, thus assuring the health integrity of children who put mainly their mouths in objects they can reach;
Also as to the external components, they are designed to present a silhouette with organic shapes, which means that is not provided with large bumps, corners, sharp edges, among other similar formations, thus avoiding that a child's body may be injured during incidental or accidental shocks with the infant use furniture;
It presents an inedited casters locking system, where the child has no access to its unlocking;
To draw the child's attention and create a safe, healthy and efficient interaction, the abovementioned external parts are provided with interchangeable elements, which may present all sorts of shapes (figures), thus drawing more attention from the child.

### BRIEF DESCRIPTION OF THE DRAWINGS

To complement this description, in order to achieve a better understanding of this invention request characteristics, we enclosed a set of drawings in which, in an exemplifying although not limitative way, a form of construction for the rotating caster used in children's furniture (or any other product) was presented, where:

FIG. 1 is a front perspective view representation of the rotating caster used in children's furniture;

FIG. 2 is a rear view representation of the rotating caster used in children's furniture;

FIG. 3 is a front perspective view representation of the rotating caster used in children's furniture, showing the interchangeable front element being assembled in the main external body;

FIG. 4 is a rear perspective view representation of the rotating caster used in children's furniture;

FIG. 5 is a perspective exploded view representation of the rotating caster used in children's furniture;

FIG. 6 represents the internal interchangeable element of the rotating caster used in children's furniture

FIG. 7 is an expanded detail representation of the interchangeable element fitting system into the rotating caster used in children's furniture;

FIG. 8 is a “XX” cross representation of the rotating caster used in children's furniture;

FIG. 9 is a side view representation of the locking system component pedal of the rotating caster used in children's furniture.

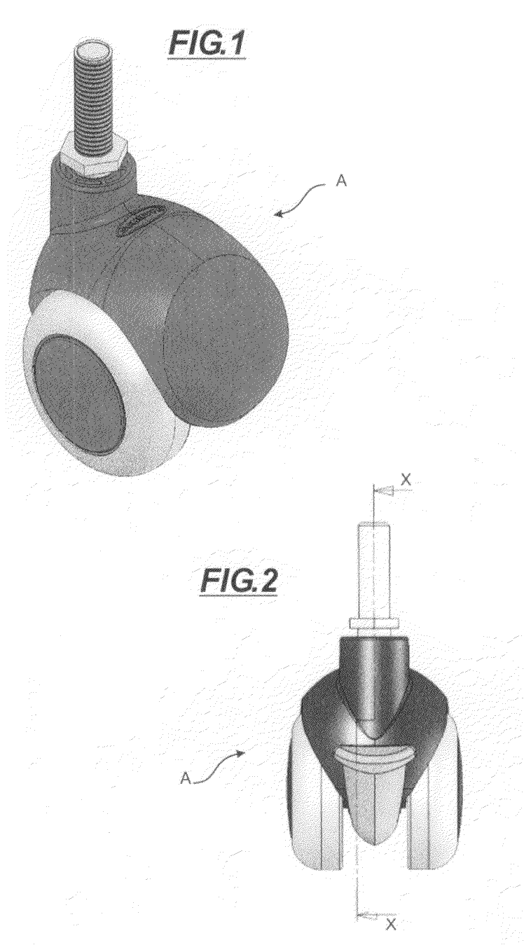

### DETAILED DESCRIPTION OF THE PREFERRED EMBODIMENTS

The following detailed description shall be read and interpreted regarding to the presented drawings, where they are highly diagrammatic, representing a construction form of the rotating caster for children's use and not being intended to restrict the invent scope, which is restricted only to what is explained in the reclaimable panorama.

Regarding to the illustrated drawings this invention patent application refers to a rotating caster for children's use of alphabetic reference A, which presents a construction formed from a structural body 1 which presents a shell 1a, defined by organic shape, with no bumps or punctiform shapes, aiming to minimize the possibility of a child being injured by the rotating caster A proper.

In its turn this structural body 1 is manufactured from differentiated raw material such as nylon 6.0 associated to fiber glass.

As to the structural body's construction 1 the latter is provided with a main housing 1b whose function lies in receiving the main rotation shaft 3 which in its turn receives in its ends 3a a pair of pulleys 4 through its housings 4a, which may also be manufactured in polymeric nature material. Additionally, those pulleys 4 present in its internal part a locking ring 4b whose bore is formed by many teeth 4c typical of a gear, since this structure is an integrating part of the locking system.

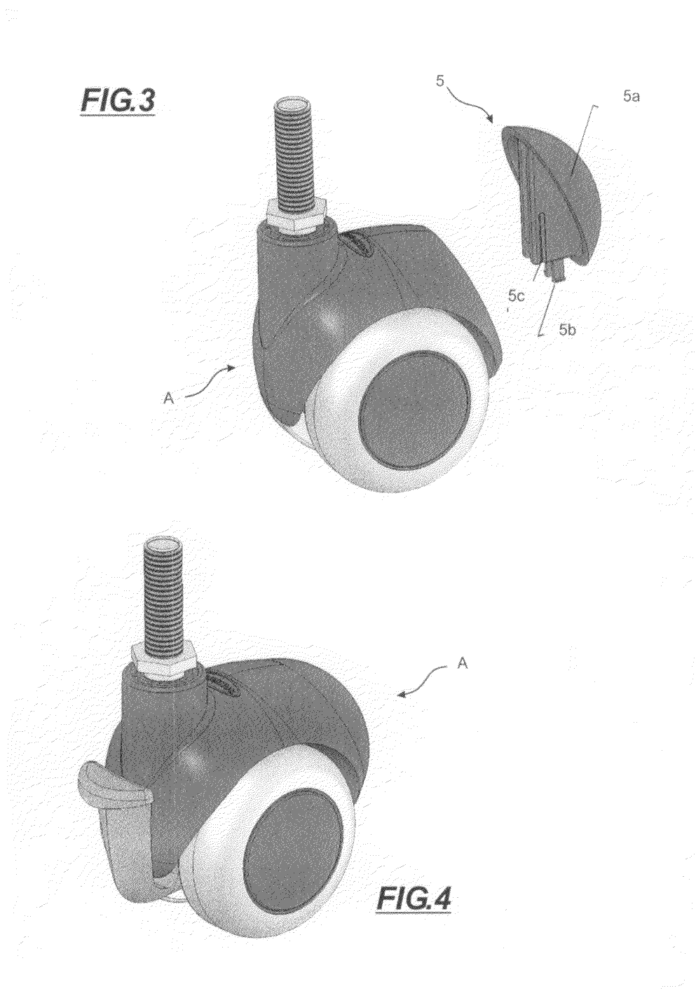

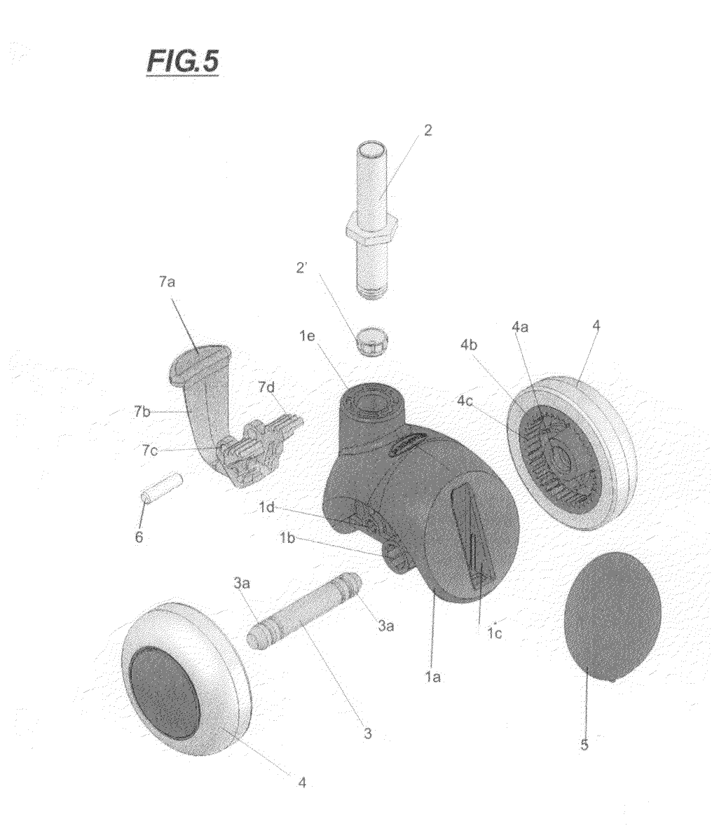

Also regarding the structural body 1 it presents a front opening 1c whose profile is designed to allow the perfect coupling of the interchangeable element 5, and part of the innovation claimed hereby lies in this element since its front face 5a, such as illustrated in FIG. 3 may present all kinds of silhouettes for application in children's use furniture, and preferably this silhouette should be exempted of any punctiform shape.

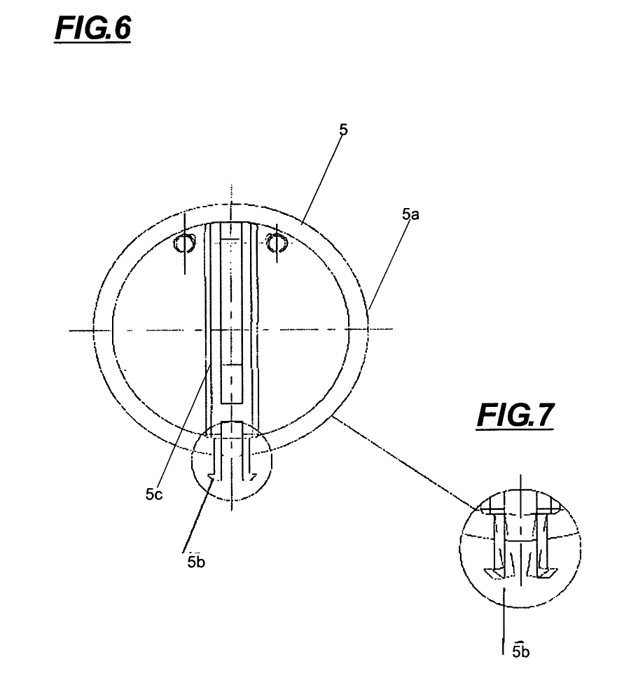

For a perfect fitting of the interchangeable element 5 into the front opening 1c, this is provided with a fitting device formed by a guide 5c which helps in the correct positioning of the interchangeable element 5 where, to provide the effective fit and locking, a pair of fitting tongs 5b is provided, the construction of which is disclosed by FIGS. 6 and 7 respectively.

An intermediate housing 1d is also foreseen whose function is to receive the secondary shaft 6 assembly which, in its turn, is an integrating part of the locking system.

As to the locking system, it presents a component pedal 7 whose function is to provide lock/unlock action to the rotating caster A pulleys 4; to receive the compression force from the user's foot or hand, this pedal is formed by a support base 7a transversally positioned at the lever segment 7b top end.

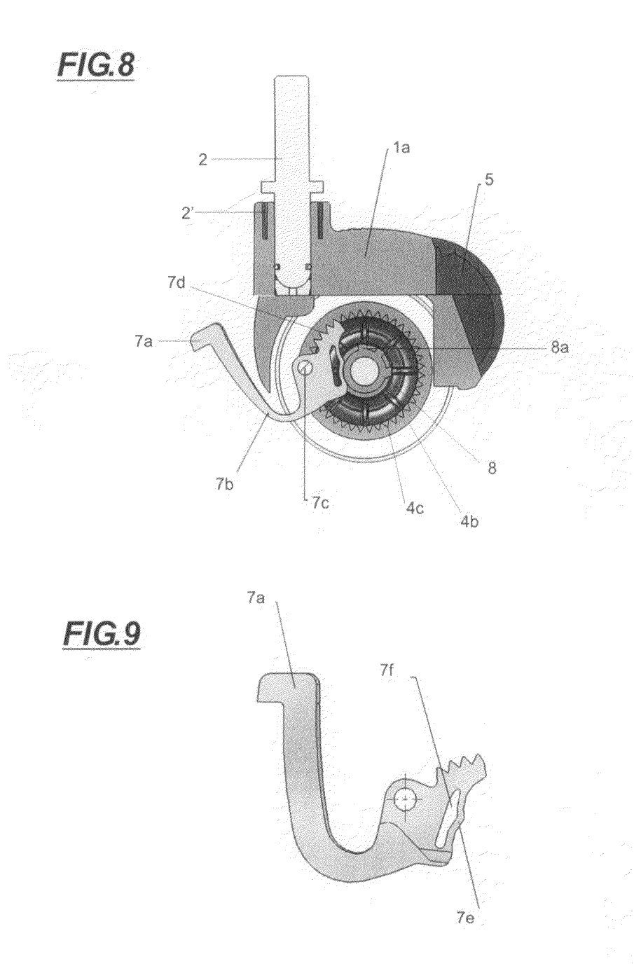

In addition this pedal 7 is fixed to the structural body 1 through the joint shaft 6 assembly passing through the joint housings 7c which, in its turn, remain positioned adjacent to the intermediate housing ends 1d, where the gear segments 7d are defined in a position adjacent to the joint housings 7c, which once they are duly assembled they interact with the teeth 4c of each one of the pulleys 4 locking ring 4b, such as illustrated in FIG. 8.

Also regarding the pedal 7, it presents a shoulder 7e whose function lies in providing locking through its discrete displacement, which is only made feasible with the existence of a relief area 7f.

To complement the inventive locking system, a nucleus 8 is also foreseen, presenting in its external diameter a shoulder 8a whose function is to provide the system with a stop.

Finally, a vertical housing 1e is foreseen in the structural body's 1 top intended to receive in its inner part a ring 2′ and the subsequent fastening of the supporting pin 2 which equalizes the rotating caster A under the furniture (or any product).

Thus, the functional logic of the locking system may be described from the pedal 7 drive which when actuated, is coupled through the joint shaft 6, which in its turn makes the lock 7e functional and thanks to the relief area 7f allows this lock 7e to pass beyond the stop, or beyond the stop shoulder 9a, preventing the pedal 7 return and its unlocking position, which the latter returns only when requested for return.

The applicant also emphasizes that there are countless possibilities of making the rotating caster device A, and for the purpose of example, the construction disclosed herein may be applied to serial casters, in the 2″ to 3″ dimensions where the holding pin may be set for three of the main types of the furniture fastening, such as a plate, a threaded spindle or still a smooth spindle.

While the presently preferred and alternative embodiments of the present invention have been described in detail above it should be understood that various other adaptations and modifications of the present invention can be envisioned by those persons who are skilled in the art of rotating caster used in children's furniture without departing from either, the spirit of the invention or the scope of the appended claims.

What is claimed is:

1) A rotating caster used in children's furniture formed by a pair of pulleys, the internal part of which presents housings receiving the ends of a main rotating shaft; this rotating caster is differentiated since it is characterized by being formed by a structural body comprised of a shell which has a main housing set which receives the main rotating shaft; a front opening in which an interchangeable element is coupled, comprised of a front face and a fitting device formed by a guide and a pair of fitting tongs; an intermediate housing to which a secondary shaft is assembled and also a vertical housing which receives a ring and a holding pin; a locking system comprised of a pedal formed by a support base transversally positioned on the lever segment top being fastened to the structural body by a coupling shaft passing by the coupling housings, which are connected to gear segments positioned beside the intermediate housing ends, the gear segments interacting with the teeth of the locking ring set in the pulleys internal part, where a shoulder with relief area is set in the lever intermediate area; the shoulder interacts with shoulder of a nucleus.

2) A rotating caster used in children's furniture according to claim 1 where the structural body is characterized for presenting an organic shape containing no sharp bumps and edges, among other punctiform shapes;

3) A rotating caster used in children's furniture according to claim 1 where the structural body is characterized for being manufactured in nylon 6.0 associated to fiber glass.

4) A rotating caster used in children's furniture according to claim 1 where the interchangeable element, in order to provide a higher visual interaction with the child, is characterized for presenting its front face set by all kinds of organic shapes accomplishable and exempt of sharp shoulders and edges among other punctiform shapes.

5) A rotating caster used in children's furniture according to claim 1 where in an accomplishment form the rotating caster device is characterized for presenting 2″ or 3″ pulleys among other measures.

6) A rotating caster used in children's furniture according to claim 1 where the rotating caster device is characterized for presenting different types of fastening to the furniture such as a plate, a threaded spindle or still a smooth spindle.
